(19) United States
(12) Patent Application Publication
(10) Pub. No.: US 2026/0161513 A1
(43) Pub. Date: Jun. 11, 2026

(54) SENSOR-TRIGGERED DATA PROTECTION FOR PHYSICAL NETWORK AND ENVIRONMENTAL CONDITIONS

(71) Applicant: Dell Products L.P., Round Rock, TX (US)

(72) Inventors: Adam Brenner, Mission Viejo, CA (US); Arun Murti, Mission Viejo, CA (US); Mark Malamut, Aliso Viejo, CA (US)

(21) Appl. No.: 18/972,143

(22) Filed: Dec. 6, 2024

(51) Int. Cl. G06F 11/14; G06F 21/31

(52) U.S. Cl. CPC G06F 11/1464; G06F 11/1461; G06F 21/31

(57) ABSTRACT

A data protection system includes a data protection server performing backup operations in accordance with defined policies. The system includes sensors measuring environmental and operating conditions to determine whether any such conditions exceed pre-defined threshold levels to indicate an event potentially affecting the system data or backup operations. Sensor data from one or more different sensors is aggregated in a sensor gateway and is transmitted to a trigger component that applies trigger logic to determine if any sensor data exceeds the threshold levels. The trigger logic also applies user-defined rules to trigger an ad-hoc backup operation if the threshold levels are exceeded and all rule conditions are met.

### TECHNICAL FIELD

This invention relates generally to data protection, and more specifically to triggering data protection operations based on environmental and operating conditions.

### BACKGROUND

Backup software is used by large organizations to store their data for recovery after system failures, routine maintenance, archiving, and so on. Backup sets are typically taken on a regular basis, such as hourly, daily, weekly, and so on, and can comprise vast amounts of information. Backup operations are usually triggered by and performed in accordance with defined policies related to the data itself, such as source and target destinations, backup periods, retention periods, and so on. Such policies are designed to replicate and protect the data from attacks against the data itself, such as cyber-attacks, and so on. In addition, ad-hoc (non-scheduled) backups can be performed to accommodate other events, such as data and virtual machine migration, system/software upgrades, business cycles (end of quarter, large social events/announcements, etc.).

Events affecting the physical condition of the data processing and storage sites, however, can equally affect data security. That is, there may be events in the user environment that do not trigger ad-hoc backups, but that jeopardize data safety, and so should trigger backups. For example damage due to fire, smoke, earthquakes, floods, and other natural, accidental or deliberate acts can easily destroy or damage the physical infrastructure and equipment of the data processing system. Any such events that affect the backup infrastructure (software and/or hardware) can easily affect data integrity, as well as the service level agreements (SLA) that set out certain service level objectives (SLO) that dictate minimum standards for important operational criteria such as uptime and response time, etc. The various protection requirements and different network entities, i.e., data sources and storage devices, that are protected by data protection policies should also be protected against these types of physical threats.

Existing approaches to addressing environmental events is purely manual and human intervention is required. Present methods of providing automatic backups are based off of regular time schedules, and do not accommodate protecting data in the event of environmental or physical events. In most cases, the manual processes are not sufficient, since manual intervention may occur too late, such as when a system administrator receives a warning of an event (e.g., fire, smoke, etc.) and then manually trigger a backup after the fact.

What is needed, therefore, is a data protection system that extends to the user's entire connected environment and provides threshold-based rules to trigger ad-hoc backups or data tiering into secure storage (e.g., off-site cyber vaults) in the event of environmental alarm conditions.

What is further needed is a system that connects IoT and edge devices as parameters to backup actions (backup, restore, tier data, send alert, etc.) and does not require human intervention once the system is initially configured.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. EMC, Data Domain and Data Domain Restorer are trademarks of DellEMC Corporation.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 illustrates a computer network system that provides automatic data protection based on physical network and environmental events, under some embodiments.

FIG. 2 illustrates a data protection system incorporating a sensor-triggered mechanism, under some embodiments.

FIG. 3 illustrates a sensor gateway and trigger component in greater detail, under some embodiments.

FIG. 4 illustrates a method of providing sensor based triggers for data protection operations, under some embodiments.

FIG. 5 illustrates the basic data elements for the method of FIG. 4, under some embodiments.

FIG. 6 illustrates a block diagram of a sensor-triggered data protection system for a multi-trigger system, under an example embodiment.

FIG. 7 is a system block diagram of a computer system used to execute one or more software components of a system and method of sensor-triggered data protection for physical network and environmental conditions, under some embodiments.

### DETAILED DESCRIPTION

A detailed description of one or more embodiments is provided below along with accompanying figures that illustrate the principles of the described embodiments. While aspects are described in conjunction with such embodiment(s), it should be understood that it is not limited to any one embodiment. On the contrary, the scope is limited only by the claims and the described embodiments encompass numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having program code stored therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or other device for storing information.

Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the certain methods and processes described herein. Applications may also be downloaded, in whole or in part, through the use of a software development kit or toolkit that enables the creation and implementation of the described embodiments. In this specification, these implementations, or any other form that embodiments may take, may be referred to as techniques. In general, the order of the steps of disclosed processes may be altered within the scope of the embodiments.

Some embodiments involve data processing in a distributed system, such as a cloud-based network system or very large-scale wide area network (WAN), and metropolitan area network (MAN), however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

A network may be embodied in any appropriate physical environment, such as a building, complex, or metropolitan/geographical area. The network can include a number of nodes, such as computers (clients, servers, etc.), processing terminals, mobile devices (mobile phones, tablet computers, game consoles, etc.). Networking equipment such as managed switches, core routers and firewall devices that provide connectivity infrastructure to both wired and possibly wireless links can also be included. The network can also include networked sensor devices, such as intrusion alarms, environmental sensors (fire, smoke, gas, seismic, etc.). Other devices can include Internet of Things (IoT) devices that are physical device or appliances that are embedded with sensors, software, and network connectivity, allowing them to collect and share data. The data produced and processed by all of these various nodes and devices can be stored and protected through a backup management system or storage server.

The computer network system 100 provides automatic data protection based on physical network and environmental events in addition to standard backup policies, under some embodiments. Network 100 includes a number of network resources, such as server computers 102, 106, desktop or portable computers 104, storage devices 118, and other similar system resources, such as physical devices 101 and sensors 122, 123. The devices generally produce and/or process data that is intended to be protected through data protection processes including backup to secure storage and restoration as needed.

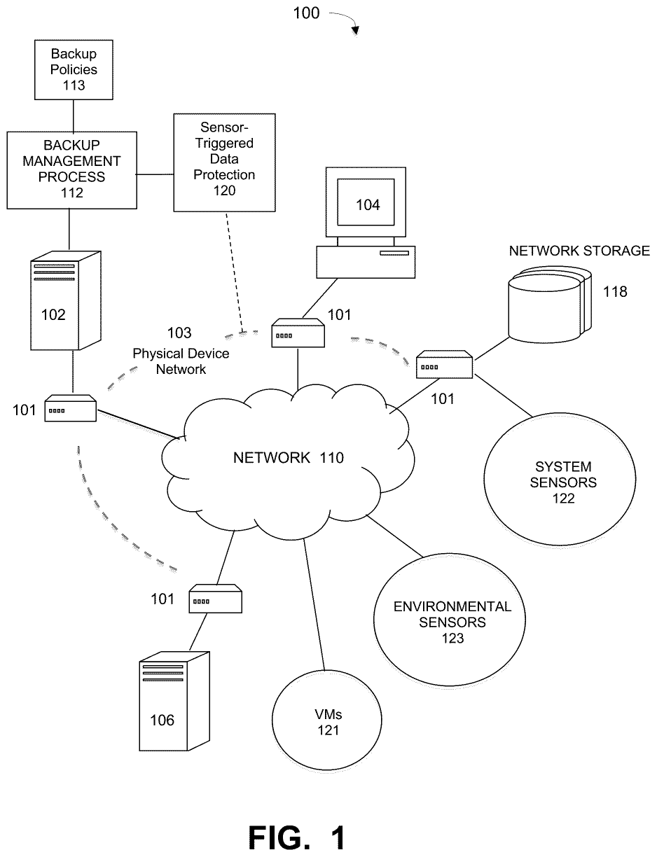

For the embodiment of FIG. 1, at least one server 102 may be a backup and/or storage server that executes a data storage or backup management process 112 that coordinates or manages the backup of data from one or more data sources to storage devices, such as network storage 118, client storage, and/or virtual storage devices. With regard to virtual storage, any number of virtual machines (VMs) 121 or groups of VMs (e.g., organized into virtual centers) may be provided to serve as backup targets. The VMs or other network storage devices serve as target storage devices for data backed up from one or more data sources, such as storage server 102 or other data source, in the network environment. The data sourced by the data source may be any appropriate data, such as database data that is part of a database management system, and the data may reside on one or more hard drives for the database(s) in a variety of formats.

The data generated or sourced by system 100 and transmitted over network 110 may be stored in any number of persistent storage locations and devices. In a backup case, the backup process 112 causes or facilitates the backup of this data to other storage devices of the network, such as network storage 118, which may at least be partially implemented through storage device arrays, such as RAID components. In an embodiment network 100 may be implemented to provide support for various storage architectures such as storage area network (SAN), Network-attached Storage (NAS), or Direct-attached Storage (DAS) that make use of large-scale network accessible storage devices, such as large capacity disk (optical or magnetic) arrays. In an embodiment, system 100 may represent a Data Domain Restorer (DDR)-based deduplication storage system, and storage server 102 may be implemented as a DDR Deduplication Storage server provided by EMC Corporation. However, other similar backup and storage systems are also possible.

The network server computers are coupled directly or indirectly to each other and other resources through network 110, which is typically a public cloud network (but may also be a private cloud, LAN, WAN or other similar network). Network 110 provides connectivity to the various systems, components, and resources of system 100, and may be implemented using protocols such as Transmission Control Protocol (TCP) and/or Internet Protocol (IP), well known in the relevant arts. In a cloud computing environment, network 110 represents a network in which applications, servers and data are maintained and provided through a centralized cloud computing platform.

For the embodiment of FIG. 1, each computer, storage device, or other resource is connected to network 110 or other resources through some sort of network equipment or interface device that may comprises a physical device network 103. The devices on this network may switches, routers, modems, or buffers that condition the data or otherwise facilitate interface of the computers with the network 110.

Depending on the network device, model, version and the customer configuration, the sensor-triggered data protection process 120 is configured to support various controlling interface protocols, such as Telnet, SSH, REST API, RestCONF, and vendor specific or similar protocols. The devices can support a pluggable driver model which adds flexibility to handle a wide variety of network devices. Each driver will support a common set of use cases, such as: commit, backup, and restore operations.

Any physical threat to the network or system site can affect the physical devices 103 as much or even more than the computers 104 themselves. Typically, computers may be securely installed, and even portable/movable, but many network devices (e.g., routers, switches, etc.) comprising edge devices are often vulnerable or fixed in place, and not easily accessible. Any damage to this equipment can just as easily compromise data integrity and backup operations as the computers themselves.

In an embodiment, the data processed by the backup manager 112 is backed up and/or restored in accordance with defined backup policies 113. These policies are defined by the user and/or system administrators to provide regular storage of important data. The policies can dictate various parameter such as data source, data target, backup frequency, storage duration, data tiering to different storage devices (e.g., high performance vs. long-term), and so on. The policies 113 allow the system to dictate which datasets are stored in which storage and how often backups are taken, etc. to meet any relevant SLO/SLA requirements.

Such policies generally protect data on a pre-defined time period, such as hourly, daily, weekly, etc., and are intended to backup data against cyber security threats, such as hacking, theft, and so on. The data, however, can also be lost or threatened due to environmental events, such as equipment failure or loss due to fires, earthquakes, floods, and so on. In this case, a normally scheduled backup policy may not initiate a defined periodic backup in time to store at least some of the critical data. Most backup management processes 112 provide for user initiated backups in case of such an emergency, but present systems require timely user intervention by a human operator.

In an embodiment, system 100 of FIG. 1 includes a sensor-triggered data protection processing component 120 that provides automatic data protection based on physical network and environmental events in addition to the normal backup policies. For this embodiment, the network 100 includes several different sensor devices, such as system sensors 122 and environmental sensors 123. The system sensors may be stand-alone devices, or they may be built-in to the network devices 101 to sense out-of-tolerance operating conditions, such as overheating, improper power conditions, physical damage, and so on. The environmental sensors may comprise any sensor that is configured to monitor and report the environmental conditions relevant to the network, such as temperature, pressure, humidity, smoke/gas, physical intrusion, fire, flood, and so on. The sensors are configured to monitor their respective characteristics and trigger a signal upon any condition that exceeds a defined threshold or threshold range defined for each sensor.

For purposes of the present description, the term “sensor” includes both system sensors and environmental sensors, and refers to any device that is configured to sense an environmental or operating condition or conditions in the system, and where an “event” comprises a condition that exceeds a defined normal operating range of the relevant system or environmental condition.

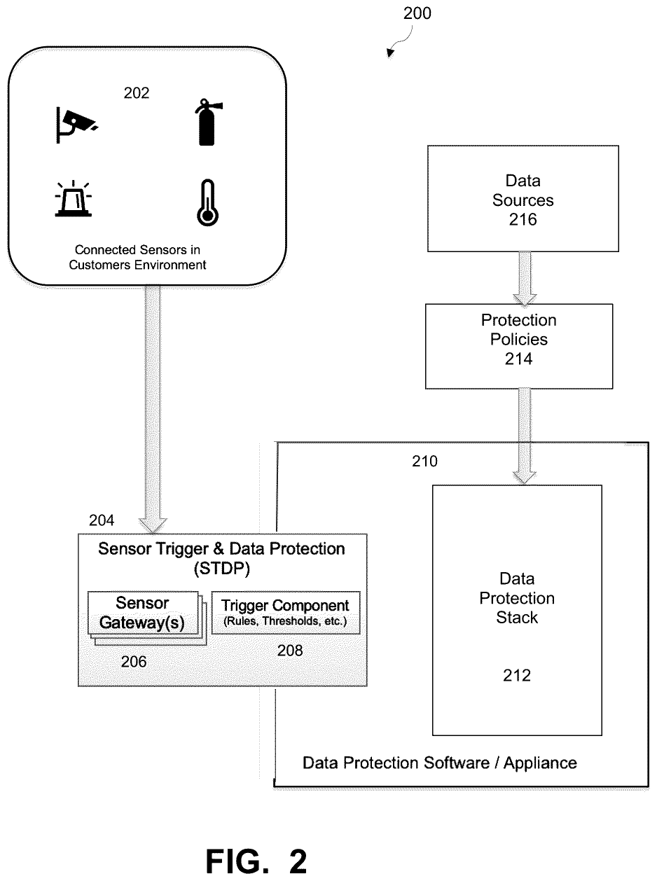

FIG. 2 illustrates a data protection system incorporating a sensor-triggered mechanism, under some embodiments. System 200 includes a set of connected sensors 202 in the user or network environment. These can include any appropriate sensor for the environment, network, data source type, and so on. Example sensors include fire and smoke sensors for buildings, temperature or humidity sensors in a data center, security cameras, door sensors, other edge sensors, and so on. The sensor data is processed by a sensor trigger and data protection (STDP) component 204 that includes a sensor gateway 206 to interface with the sensors, and defined rule and thresholds maintained by a trigger component 208. The STDP 204 interfaces with the data protection system 210, which includes a data protection stack 212 that backups and restores data in accordance with defined policies 214 and other instructions.

The data protection stack executes the relevant backup and restore functions. Backing up data generally involves a series of stages. The first stage might be copying the data in a form of a snapshot of a VM, file system, block device, database, and so on. Another stage is the movement of that copy to another location like secondary storage. Certain user environments might have more stages afterwards, such as tiering the data to the cloud or replicating the data for disaster recovery.

The data processed in system 200 can include standard production data derived from data sources 216, such as databases, client computers, and so on, which is then protected under the one or more protection policies 214 by the data protection stack 212. The other type of data. The protection policies 214 define certain parameters of data storage and restoration, such as backup frequency, storage targets, and so on, and generally operate in accordance with set schedules. The backup processes can also be triggered off-schedule on an ad-hoc basis by events sensed by the sensors 202 so that data is automatically backed up in the event of a possibly destructive event or condition.

In an embodiment, the sensors 202 can include any suitable sensor device that senses an corresponding condition. These can include temperature sensors, pressure sensor, smoke/gas detectors, cameras, microphones, intrusion alarms, seismic sensors, IoT devices and so on. The sensor data is input to the sensor gateway interface 206 of the STDP 204. The sensor gateway 206 allows for one or more sensor or devices (e.g., cameras, alarms, IoT devices, etc.) to push data to the gateway via certain sensor reading components. In general, the sensors may communicate using different forms of communication and therefore require different sensor reading components to interact with the system. These may include, for example, a direct hardware connection over copper wire (18AWG, etc.), IPv4/IPv6 protocols (TCP, UDP, SNMP, REST, etc.), special wireless frequencies (Z-band, etc.), or any other appropriate interface.

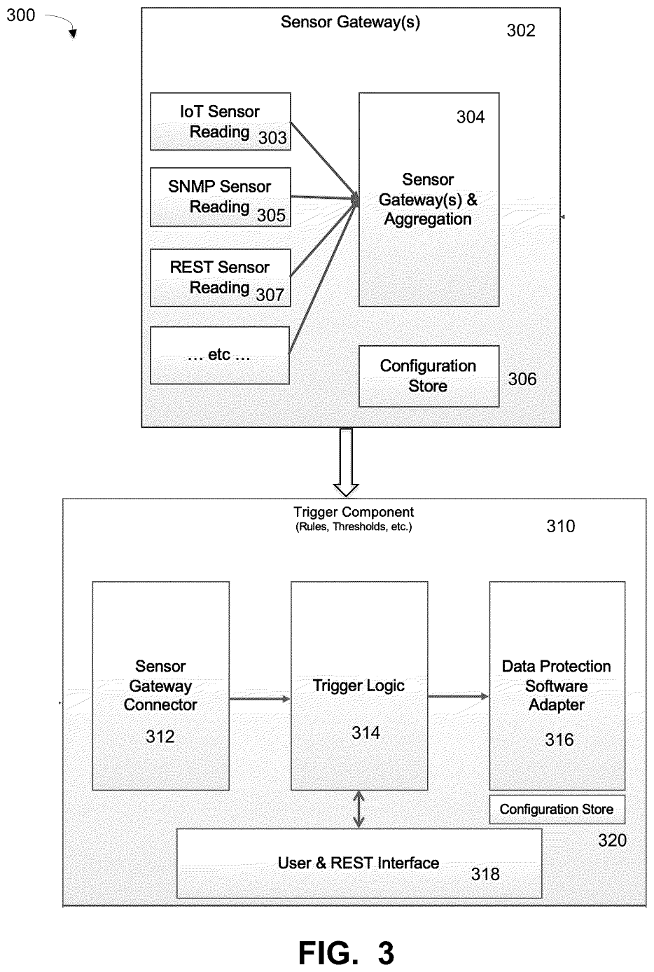

FIG. 3 illustrates a sensor gateway and trigger component in greater detail, under some embodiments. A configuration store 306 in stores relevant data for the sensors, such as values, units, configurations, and so on. It also stores sensor connection details, such as port specifiers (IPv4, IPv6, COM port, serial port, etc.) as well as SNMP details, username, password, REST endpoints for connection, and so on.

As shown in FIG. 3, the sensor gateway 302 collects sensor data as sensor readings from the various devices or interfaces, such as IoT readings 303, SNMP (simple network management protocol) reading 305, REST sensor readings 307, and/or any other sensor devices or interfaces. This data is then aggregated in the gateway and aggregation component 304 so that the sensor readings can be pushed to the trigger logic component 310. In general, the sensor gateway 302 is an independent component that can be deployed and scaled independently to the rest of the system.

The aggregation function can be tailored depending on the sensor signals and combinations, such as by averaging or taking the mean of various values. For example, a sensor might record a high and low value (i.e., a value range) for a given period before reporting to the sensor gateway. An aggregation might take an average of the high and low value that is returned to the system, as opposed to two different values. In another example, there might be multiple sensors deployed in a physical data center (e.g., row 1, row 2, row 3, etc.). The system may aggregate sensor data for the overall data center with room temperature as a trigger versus a particular datacenter row. In this case, the aggregation would be for all sensors and reported back as one unit to the trigger component. In some cases, a high or low value within a range may be selected as the aggregate value for a number of sensors, such as in the case where the highest temperature encountered in the system is meant to trigger a backup operation.

The trigger component 310 receives data from one or more sensor gateways 302. Multiple sensor gateways can be deployed to handle load and provide high availability. The trigger component 310 contains a sensor gateway connector 312 as the physical and logical interface to the sensor gateway(s) 302. The trigger logic component 314 accesses or stores the rules and threshold values to execute the sensor readings against the thresholds for the relevant rules. The outcome of the rule execution is then input to a data protection software adapter 316 to trigger the appropriate data protection operation, such as data backup, migration, tiering, and so on. The trigger component 310 can also include an interface (UI or/and REST API) 318 to configure the triggers, as maintained in a configuration store 320.

In an embodiment, the user adds or stores their credentials and any required information for the data protection software (e.g., PPDM). This allows the appropriate backup/restore operations to be executed automatically by the data protection software upon the occurrence of a triggering event, without any manual input by the user. These credentials are stored in the configuration store 320 within the trigger component 310. These credentials may be formatted in any appropriate manner in accordance with the requirements and configuration of the system, such as may be defined by corporate access restriction rules, human resource (HR) definitions, and so on.

In an embodiment, the triggers comprise user or system-defined rules and actions. A rule is a specific value or range of values that correspond to units and values for each of the sensors. For example, a temperature sensor may be calibrated to express measurement in degrees Celsius or Fahrenheit, and thus a threshold may comprise a minimum reading (e.g., 150° F, for temperature) to activate a corresponding trigger. Likewise, an intrusion alarm may be a simple binary state switch that is normally 0 but activates a trigger when it switches to state 1, and so on

In an embodiment, standard database rules can be used to formulate rules using operators such as OR, AND, NOT, and so on, with standard numerical value/range definitions and wildcards. For example, the rules “Trigger an alarm (email, REST call, data migration etc.) IF Sensor_1>=100F AND Location==“LAX” OR Sensor_1<=60F AND Location==“LAX”” will trigger an alarm if the Los Angeles datacenter is too hot or cold. Any other similar rules can be formulated using system or self-defined nomenclature.

An action is a data protection operation that is performed when a rule has been matched through a defined threshold being met or exceeded by a sensor reading. Such actions could be any of the standard data protection operations, such as backup data, restore data, tier data, migrate data, send an alert, and so. The triggers can encompass one or more rules and actions. The trigger component 310 continuously evaluates data coming from sensor gateway 302 and determines if a trigger threshold is met. Data protection software adapters 316 may be used to allow actions to be implemented via interfaces to the user's data protection software (e.g., PowerProtect Data Manager, PPDM).

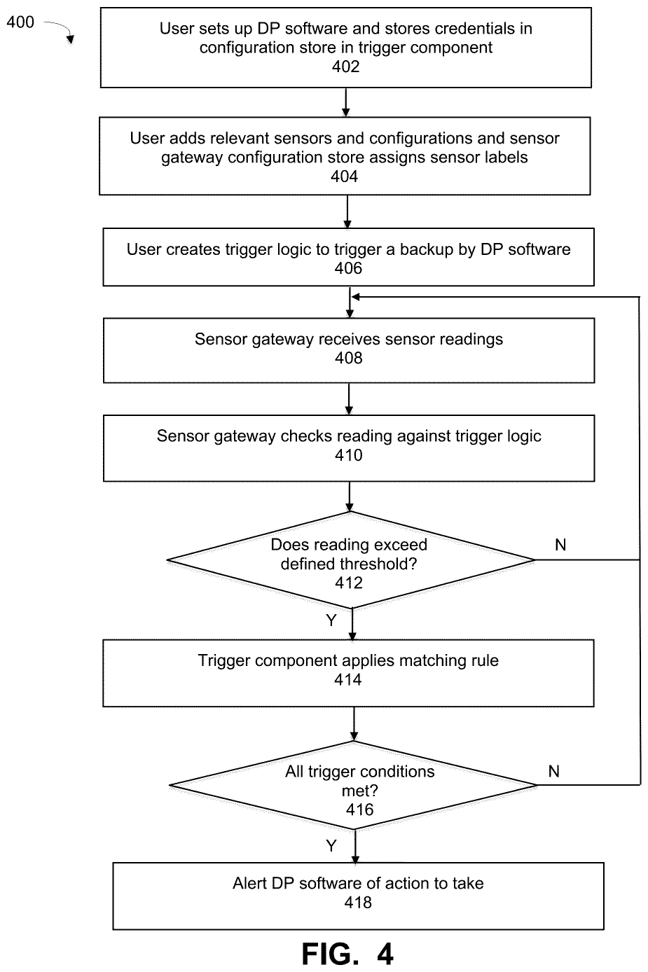

FIG. 4 illustrates a method of providing sensor based triggers for data protection operations, under some embodiments. The overall method 400 comprises two main processes of setup workflow (steps 402 to 406) and trigger workflow (steps 408 to 418). A first step of process 400 is the user logging into the system (such as through the REST) interface ad adding credentials and information for the data protection (DP) software, 402. These credentials are stored in the configuration store 320 of the trigger component 310. The user then logs into the system to add relevant sensors and configurations. The configuration store 306 in the sensor gateway 302 assigns relevant ports or interfaces to the sensors as labeled with the appropriate names, 404. For example, a door sensor named “Main entryway” may be configured as a hardwired sensor assigned to port 1.

The sensor type may also be specified. For example, triggers may be based on various different sensor types, such as Boolean (yes/no), min/max threshold values or ranges (numeric), or qualitative parameters (e.g., poor/fair/good, low/medium/high/very_high), and so on. Some triggers may also implicate or require other measurements, such as timers to measure an elapsed time since an event, or trigger events that require a combination of sensors, such as movement plus intrusion sensors. Any number and type of sensors and configurations may be so configured. A simple type of trigger is a Boolean trigger that activates on either a high/low, 1/0, yes/no, on/off, or similar state. For example, a door sensor may trigger on whether the door is open or closed, thus providing a Boolean value (1/0) that corresponds to a door being opened or closed.

In step 406, the user creates the trigger logic to trigger an operation by the DP software (e.g., backup) when a sensor detects an event. A subset of the trigger logic is also stored in the sensor gateway so that it can aggregate results. This subset is used to provide references for complex setups where a trigger may operate on multiple sensors. For example, a rule may reference a Boolean sensor as well as other aggregated sensors, and the trigger logic needs this information to aggregate the results of all of the sensors. For example, a door sensor is a simple Boolean (open/closed) state, but may act with another sensor that is an aggregation of all temperature sensors in the data center. A more rule for this scenario might be: Trigger a backup IF Door_Sensor_1==OPEN AND Sensor_Temp>=100F, where Sensor_Temp is an aggregation of sensor_row_1, sensor_row_2, sensor_3, etc.

During operation, the system monitors the sensors and receives sensor readings through the sensor gateway, 408. The sensors may be configured to transmit at regular periodic intervals, or they may be polled by the data protection system. They may also send a signal only upon a change of state, such as from a binary off to on, or a change in output value.

In step 410, the sensor gateway checks the value of the sensor readings against the trigger logic from its own configuration store 306 to determine whether or not a trigger needs to be notified, such as if a defined threshold value has been exceeded, 412. If not, the system continues to process the sensor readings from step 408. If so, however, the trigger component receives information from the sensor gateway that a trigger condition has been met, and checks its internal configuration store 320 to find the matching rule 414. For the door alarm example, a stored configuration could be that the sensor indicates that door has been open for five minutes or more, in which case the sensor gateway 302 will alert the trigger component 310.

The system then determines if all trigger conditions have been met, 416. If not, the system continues to process the sensor readings from step 408. If, however, a trigger has met all conditions, the trigger component alerts the data protection software of what action to take, such as a backup operation, 418.

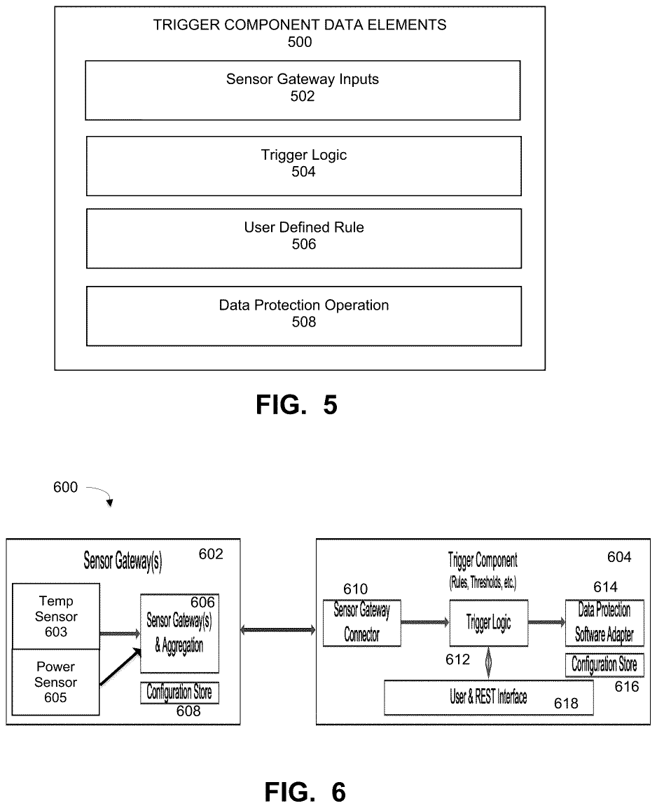

FIG. 5 illustrates the basic data elements 500 used in process 400, under some embodiments. These comprise the sensor gateway inputs 502, the trigger logic 504, the user defined rules 506, and the data protection operation 508.

For the data center door monitoring example, the sensor gateway inputs could comprise a simple door monitoring and Boolean door open detector. The trigger logic could be defined as: “When the door to data center entrance is opened for longer than 5 minutes, trigger a backup.” A user defined rule would thus be: when a door is opened for longer than 5 minutes, trigger a backup event, where the data protection operation is a backup. This example is a simple single sensor and single rule application. The system may include many sensors and rules, depending on system configuration and complexity.

For example, a multi-trigger system may include rules to trigger a backup event if the temperature in a data center exceeds a certain temperature, and if a majority of the rack components are exceeding a certain circuit capacity. FIG. 6 illustrates a block diagram of a sensor-triggered data protection system for this scenario, under an example embodiment. For this example, the sensor gateway602 inputs in system 600 would comprise at least room temperature sensors 603 and rack power monitors 605. The trigger logic 612 in trigger component 604 could be encoded as “When all of: Temperature exceeds 80F and 51% of PDUs exceeds 80% of circuit capacity” then trigger a backup for those data assets within the data center and tier the data off-site.

For this example, the user, whose credentials are loaded into the configuration store 616 of the trigger component 604, could log into the user and REST interface 618 to add a temperature sensor 603 definition, such as: “Floor 1, POD A Temperature Sensor.” Such a sensor could be a wireless low frequency Z-band that is connected to the sensor gateway 602 on port 1. The configuration store 608 in the sensor gateway will assign port 1 this temperature sensor with a label “Floor 1, POD A Temperature Sensor.”

The same process is repeated for the power (PDU) sensor(s) 605 where they might be connected via SNMP over a network and labeled “Floor 1, POD A, Cab 1, PDU-1,” and so on, for the total number of power sensors present in the system.

The user creates trigger logic rules such that when a value of 80F or greater is on label “Floor 1, POD A Temperature Sensor” AND when a value of 80% of greater is on label “Floor 1, POD A, Cab 1, PDU-1” are met, this will trigger a backup and tiering of the data, which is transmitted to the data protection server by the data protection software adapter 614. This rule and threshold information is stored in configuration store 616 within the trigger component 604, and a subset of the trigger logic is also stored in the sensor gateway 606 so that it can aggregate results of all the sensors (e.g., 603, 605). The aggregated sensor gateway information is then passed to the trigger component 604 through the sensor gateway connector 610.

The embodiment of FIG. 6 is provided for purposes of illustration only, and a sensor network of any size and scale can be used, depending on system configuration and requirements. Any number of sensors of various types can be used with corresponding defined rules provided by the user.

The sensor gateway and trigger component system provides an effective mechanism to trigger ad-hoc backups based on data protection operations triggered by environmental or operating events that may threaten, compromise, or destroy the data stored in the system.

In an embodiment, the data protection or backup operations are triggered to be performed on an ad hoc basis, that is, out of sequence of a normal policy-based backup schedule. The system may also be configured to perform triggered backups as part of a pre-defined schedule, or on a separate periodic basis as needed to overcome any threat to the system due to environmental or operating issues. Periodic backups can also be used to check and clear certain fault situations, such as if a sensor is stuck on a value. In this case, periodically triggering a backup operation may help identify this fault.

### System Implementation

Embodiments of the processes and techniques described above can be implemented on any appropriate backup system operating environment or file system, or network server system. Such embodiments may include other or alternative data structures or definitions as needed or appropriate.

The processes described herein may be implemented as computer programs executed in a computer or networked processing device and may be written in any appropriate language using any appropriate software routines. For purposes of illustration, certain programming examples are provided herein, but are not intended to limit any possible embodiments of their respective processes.

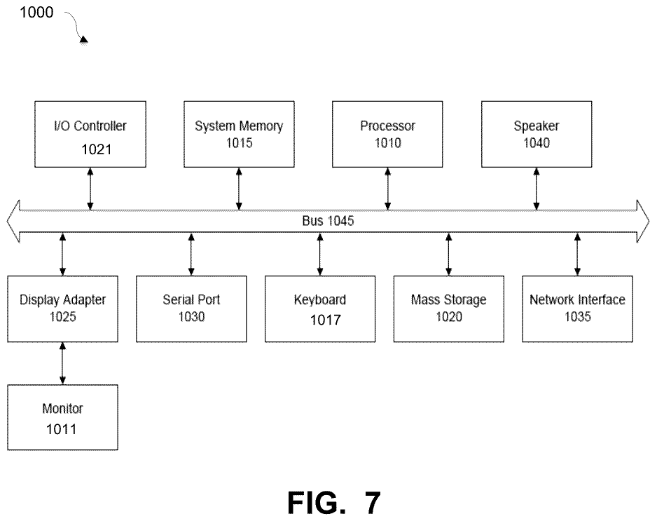

The network of FIG. 1 may comprise any number of individual client-server networks coupled over the Internet or similar large-scale network or portion thereof. Each node in the network(s) comprises a computing device capable of executing software code to perform the processing steps described herein. FIG. 7 shows a system block diagram of a computer system used to execute one or more software components of the present system described herein. The computer system 1000 includes a monitor 1011, keyboard 1017, and mass storage devices 1020. Computer system 1000 further includes subsystems such as central processor 1010, system memory 1015, I/O controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 is just one example of a computer system suitable for use with the present system. Other configurations of subsystems suitable for use with the described embodiments will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

An operating system for the system 1005 may be one of the Microsoft Windows®. family of systems (e.g., Windows Server), Linux, Mac OS X, IRIX32, or IRIX64. Other operating systems may be used. Microsoft Windows is a trademark of Microsoft Corporation.

The computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of the system using a wireless network using a protocol such as Wi-Fi (IEEE standards 802.11x), near field communication (NFC), radio-frequency identification (RFID), mobile or cellular wireless. For example, signals from a computer may be transferred, at least in part, wirelessly to components or other computers.

In an embodiment, with a web browser executing on a computer workstation system, a user accesses a system on the World Wide Web (WWW) through a network such as the Internet. The web browser is used to download web pages or other content in various formats including HTML, XML, text, PDF, and postscript, and may be used to upload information to other parts of the system. The web browser may use uniform resource identifiers (URLs) to identify resources on the web and hypertext transfer protocol (HTTP) in transferring files on the web.

For the sake of clarity, the processes and methods herein have been illustrated with a specific flow, but it should be understood that other sequences may be possible and that some may be performed in parallel, without departing from the spirit of the described embodiments. Additionally, steps may be subdivided or combined. As disclosed herein, software written in accordance certain embodiments may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method of triggering a data protection operation for a data protection system, comprising:
receiving sensor data from one or more sensors deployed in the system;
first determining whether the sensor data exceeds a pre-defined threshold value for a characteristic measured by the one or more sensors;
applying, if the sensor data exceeds the pre-defined threshold, a user-defined rule to trigger a data protection operation;
second determining if all conditions of the rule are satisfied; and
triggering, if all conditions the rule are satisfied, a data protection server to perform a specified data protection operation.

2. The method of claim 1 wherein the one or more sensors comprise devices measuring at least one of environmental and operating conditions of the system sensors.

3. The method of claim 2 wherein the one or more sensors are implemented as either standalone devices or as components built-in to one or more network equipment devices or computers in the system.

4. The method of claim 3 wherein the network devices comprise at least one of managed switches, routers, or firewall devices, and wherein the one or more sensors comprise at least one of: fire detectors, smoke detectors, intrusion sensors, or seismic sensors.

5. The method of claim 1 wherein the data protection operation is selected from data protection operations comprising at least one of a backup operation, a restore operation, a data migration operation, or a data tiering operation.

6. The method of claim 1 wherein the data protection operation is triggered on an ad-hoc basis to supplement a normally scheduled data protection operation performed in accordance with a defined policy that dictates routine backup schedules, data sources, and storage targets.

7. The method of claim 1 wherein the user-defined rule specifies a sensor type, sensor name, sensor configuration, and threshold condition.

8. The method of claim 7 wherein the sensor type comprises one of a Boolean sensor outputting a binary on or off signal or a variable sensor outputting a range of values within a total range.

9. The method of claim 8 wherein the user-defined rule comprises threshold criteria for each of a plurality of sensors of the one or more sensors, and wherein each threshold criteria must be met or exceeded to cause the triggering step, and wherein sensor data from each of the plurality of sensors is aggregated in a sensor gateway component coupled to a trigger component executing the user-defined rule.

10. The method of claim 9 further comprising:
storing sensor information in a first configuration store provided in the sensor gateway component; and
storing credentials of a user providing the user-defined rule in a second configuration store provided in the trigger component.

11. An apparatus triggering a data protection operation for a data protection system, comprising:
a sensor gateway producing sensor data from one or more sensors deployed in the system;
a first configuration store in the sensor gateway storing configuration information of the sensors;
a trigger component coupled to the sensor gateway containing trigger logic first determining whether the sensor data exceeds a pre-defined threshold value for a characteristic measured by the one or more sensors;
a second configuration store in the trigger component containing credentials of a user defining a rule;
a trigger logic of the trigger component applying the rule to trigger a data protection operation by a data protection server when one or more conditions set by the rule are satisfied by sensor readings of the one or more sensors.

12. The apparatus of claim 11 wherein the one or more sensors comprise devices measuring at least one of environmental and operating conditions of the system sensors, and are implemented as either standalone devices or as components built-in to one or more network equipment devices or computers in the system.

13. The apparatus of claim 12 wherein the network devices comprise at least one of managed switches, routers, or firewall devices, and wherein the one or more sensors comprise at least one of: fire detectors, smoke detectors, intrusion sensors, or seismic sensors.

14. The apparatus of claim 11 wherein the data protection operation is selected from data protection operations comprising at least one of a backup operation, a restore operation, a data migration operation, or a data tiering operation, and wherein the data protection operation is triggered on an ad-hoc basis to supplement a normally scheduled data protection operation performed in accordance with a defined policy that dictates routine backup schedules, data sources, and storage targets.

15. The apparatus of claim 11 wherein the user-defined rule specifies a sensor type, sensor name, sensor configuration, and threshold condition.

16. The apparatus of claim 15 wherein the sensor type comprises one of a Boolean sensor outputting a binary on or off signal or a variable sensor outputting a range of values within a total range.

17. The apparatus of claim 16 wherein the user-defined rule comprises threshold criteria for each of a plurality of sensors of the one or more sensors, and wherein each threshold criteria must be met or exceeded to cause the triggering step, and wherein sensor data from each of the plurality of sensors is aggregated in a sensor gateway component coupled to a trigger component executing the user-defined rule.

18. A computer-implemented method of triggering a data protection operation for a data protection system, comprising:
collecting sensor data measuring one or more environmental or operating conditions of the system;
determining if the sensor data exceeds one or more corresponding threshold values to trigger an ad-hoc backup operation to supplement a regularly scheduled backup operation performed in accordance with a backup policy;
executing, if the sensor data exceeds a threshold value, a rule triggering the ad-hoc backup operation.

19. The method of claim 18 wherein the rule is defined by a user having credentials stored in a trigger component performing the executing step, and further wherein sensor information for the sensors generating the sensor data are stored in a sensor gateway transmitting the sensor data to the trigger component, and further wherein the user-defined rule specifies a sensor type, sensor name, sensor configuration, and the threshold values.

20. The method of claim 19 wherein the one or more sensors comprise devices measuring at least one of environmental and operating conditions of the system sensors, and are implemented as either standalone devices or as components built-in to one or more network equipment devices or computers in the system, and further wherein the sensor type comprises one of a Boolean sensor outputting a binary on or off signal or a variable sensor outputting a range of values within a total range.
